(19) United States
(12) Patent Application Publication
(10) Pub. No.: US 2004/0015449 A1
(43) Pub. Date: Jan. 22, 2004

(54) Remote witnessed analysis system

(76) Inventors: Hideaki Imai, Fuji-shi, Shizuoka (JP); Teiichiro Kohno, Fuji-shi, Shizuoka (JP); Sadao Ibe, Nakano-ku, Tokyo (JP)

Correspondence Address: FINNEGAN, HENDERSON, FARABOW, GARRETT & DUNNER, LLP, 1300 I STREET, NW, WASHINGTON, DC, 20005, US

(21) Appl. No.: 10/312,340

(22) PCT Filed: Jun. 27, 2001
(86) PCT No.: PCT/JP01/05533

(30) Foreign Application Priority Data
Jun. 27, 2000 (JP) 2000-192835
Nov. 10, 2000 (JP) 2000-343559

(51) Int. Cl. H04K 1/00

(52) U.S. Cl. 705/52

(57) ABSTRACT

A terminal on the side of a pretreatment apparatus, a terminal on the side of a measurement apparatus and a terminal on the data analysis side are connected to a terminal on the client side, to a server for displaying the fees and to a server for data analysis through a communication circuit. The data obtained from the pretreatment apparatus or the measurement apparatus are displayed on the screens at the terminal on the side of the pretreatment apparatus, at the terminal on the side of the measurement apparatus and at the terminal on the client side. The data obtained from the server for data analysis are displayed on the terminal on the data analysis side and on the terminal on the client side. Each terminal is provided with communication means, and a person in charge of the pretreatment, a person in charge of the measurement or a person in charge of the data analysis and the client work to carry out the processing while viewing their respective screens and maintaining communication between them. On the screen are displayed indication means indicated by the person in charge and indication means indicated by the client, enabling the person in charge and the client to communicate their intentions. The fees incurred thus far can also be displayed on the screen.

### TECHNICAL FIELD

The present invention relates to a system for executing pretreatment, measurement and data analysis of samples. More specifically, the invention relates to a system which enables a person in charge of pretreatment, a person in charge of measurement or a person in charge of data analysis and a client at a distance to share data in real time, and to properly and quickly solve a problem.

The invention further relates to terminals used for the above system and to a method executed in the above system.

### BACKGROUND ART

It is, in general, a practice for a client who requests a measurement to take the following procedure.

(1) The person in charge of a consultation makes a previous arrangement (consultation of analysis) with the client to determine how the measurement is to be conducted (design of analysis).

(2) Based upon this, the person in charge of the consultation prepares an estimate.

(3) The client requests the measurement.

(4) The person in charge of the pretreatment conducts the pretreatment of the sample in accordance with the content that was determined.

(5) The person in charge of the measurement conducts the measurement of the sample in accordance with the content that was determined.

(6) The person in charge of the data analysis conducts the data analysis of the measured results.

(7) The client is informed of the data analysis results.

The person in charge of the consultation, the person in charge of the pretreatment, the person in charge of the measurement and the person in charge of the data analysis need not be separate persons but may be, for example, a single person. Further, the measurement and the data analysis may be conducted by the same person.

In consulting the data analysis (1), the person in charge of the consultation may often find it difficult to perfectly grasp the situation in which the sample is placed. In such a case, the pretreatment determined by the consultation in the step (1) may not be appropriate, and it may happen that portions that should have been observed or measured are missing, or portions that should not have been observed or measured are put into the measurement.

Depending upon the content of the measurement, further, even the client may not have been perfectly aware of the situation in which the sample is placed. In an failure analysis of a device, for example, it is difficult to pinpoint defects causing trouble with high precision though it can be pinpointed to some extent. Therefore, the cause of the trouble is specified by searching for the cause of the trouble by grinding the apparatus little by little by using a focused ion beam machining apparatus (FIB).

Further, in actually conducting the pretreatment (4), it may often happen that situations are observed or a problem arises, which were not anticipated even by the client. In conducting the machining, for example, a structure different from the anticipated structure may be observed, or the material may be modified through the pretreatment. When such a case is encountered, the person in charge of the pretreatment renders his own judgement based upon the item (1) above or upon his technical knowledge of the materials, and changes and determines the subsequent method of measurement.

However, the person in charge of the pretreatment may not have much knowledge of the material to be measured compared with the client, and may find it difficult to render a proper judgement. In such a case, the person in charge of the pretreatment may discuss the matter with the client over the telephone. However, talking over the telephone cannot avoid the limitation of transmission of information in a correct form. If the pretreatment is conducted in a wrong direction, therefore, the portions that should have been measured may often be lost or irrelevant portions may be treated making it necessary to conduct the pretreatment all over again, resulting in an excess of pretreatment and excess of expenditures. In the worst case, it could happen that the portion that should have been measured is lost by the pretreatment.

Next, in conducting the measurement (5), it could happen that the person who conducts the measurement observes a result that was not expected from the consultation (1). In this case, the results necessary for accomplishing the object may not be obtained even if the measurement is continued in accordance with the design of the measurement as determined in the item (1). When such a case is encountered, therefore, the person in charge of the measurement renders his own judgement based upon the content consulted in the item (1) or upon his technical knowledge of the materials, and changes and determines the subsequent method of measurement. However, the person in charge of the measurement may not have much knowledge of the material to be measured compared with the client, and may find it difficult to render a proper judgement.

In data analyzing the measured results (6), further, the client's knowledge concerning the properties of the samples to be measured and concerning the production, plays an important role. When the client is at a distance, however, the person in charge of the data analysis may not be able to utilize the knowledge and may not often be able to conduct the data analysis to a sufficient degree.

A service is provided for avoiding these problems. According to this service, the client visits the analytical service organization on the day of conducting the pretreatment, measurement or data analysis to have the pretreatment, measurement and data analysis conducted being attended by the person in charge of the treatment. In this case, even if there occurs a situation that had not been expected by the client during the pretreatment, measurement or data analysis, the matter can be discussed with the person in charge of the pretreatment, and the subsequent direction to be taken can be flexibly changed and determined. This alleviates the above-mentioned problems. Further, the client is enabled to return on that day carrying with him the measured data.

This method is ideal from the standpoint of conducting the pretreatment, measurement and data analysis, but has not necessarily been extensively employed since the client must visit the measuring organization on the day of conducting the pretreatment, measurement and data analysis with the added cost and time for travel. Further, the work actually involved in the pretreatment, measurement and data analysis includes much waiting time during which the client's attendance and is not required. The client who is visiting the measuring organization is not allowed to return to his normal work even during such a time, and much time is wastefully consumed.

It is an object of the present invention to provide a system capable of conducting the pretreatment, measurement and data analysis of the sample and of obtaining proper results liberating the client from the need of visiting the measuring organization, to provide terminals used for the system, and to provide a method executed in the system.

### DISCLOSURE OF THE INVENTION

The present invention was proposed to accomplish the above-mentioned object. The system of the present invention is so constituted that a terminal on the side of the pretreatment device, a terminal on the side of the measurement apparatus and a terminal on the data analysis side are connected to a terminal on the client side, to a server for displaying the fees and to a server for data analysis through a communication circuit. Further, the data obtained from the pretreatment apparatus or the measurement apparatus are displayed on the screen at the terminal on the side of the pretreatment apparatus or on the screen at the terminal on the side of the measurement apparatus, and part or all of the data are displayed on the terminal on the client side. The data obtained from the measured results are displayed on the screen at the terminal on the data analysis side from the server for data analysis, and part or all of the data are displayed on the terminal on the client side.

A communication unit is provided for maintaining communication between the person in charge of the pretreatment, the person in charge of the measurement or the person in charge of the data analysis and the client. The person in charge of the pretreatment, the person in charge of the measurement or the person in charge of the data analysis and the client, confirm the data displayed on the screens of their terminals and continue with the processing maintaining communication using the communication unit. Thus, without the need of visiting the distant organization, the client is allowed to obtain the results of the pretreatment, measurement and data analysis as when visiting the organization.

On the screens of the display units at the terminal on the side of the pretreatment device, at the terminal on the side of the measurement apparatus, at the terminal on the data analysis side and at the terminal on the client side, further, there are displayed indication means such as a pointer indicated by the person in charge of the pretreatment, by the person in charge of the measurement, by the person in charge of the data analysis and, by the client. Then, portions that require the attention of the persons in charge or of the client are indicted by the indication means enabling the intentions of the individual persons to be more reliably transmitted to the others.

In the system of the present invention, further, the fees incurred thus far can be displayed on the screen of the display unit at the terminal on the client side. Thus, the client is allowed to know the required fees and avoid conducting unnecessary pretreatment, measurement or analysis.

### BRIEF DESCRIPTION OF THE DRAWINGS

FIG. 1 is a diagram illustrating a first embodiment of a system to which the present invention is applied;

FIG. 2 is a diagram illustrating the constitution of a terminal on the side of the pretreatment apparatus of FIG. 1;

FIG. 3 is a diagram illustrating the constitution of a terminal on the side of the measurement apparatus of FIG. 1;

FIG. 4 is a diagram illustrating the constitution of a server for displaying the fees of FIG. 1;

FIG. 5 is a diagram illustrating the constitution of a server for data analysis of FIG. 1;

FIG. 6 is a diagram illustrating the constitution of a terminal on the client side of FIG. 1;

FIG. 7 is a diagram illustrating the former half of a flowchart illustrating a flow of a virtual analytical collaboration system to which the present invention is applied;

FIG. 8 is a diagram illustrating the latter half of the flowchart illustrating the flow of the virtual analytical collaboration system to which the present invention is applied;

FIG. 9 is a flowchart illustrating in detail the communication in the process of FIG. 8;

FIGS. 10A and 10B show screens displaying the pretreatment data according to the invention;

FIGS. 11A and 11B show screens displaying the measured data according to the invention;

FIGS. 12A and 12B show screens displaying the analytical data according to the invention; and

FIG. 13 is a diagram illustrating the constitution of a terminal on the data analysis side in FIG. 1.

### BEST MODE FOR CARRYING OUT THE INVENTION

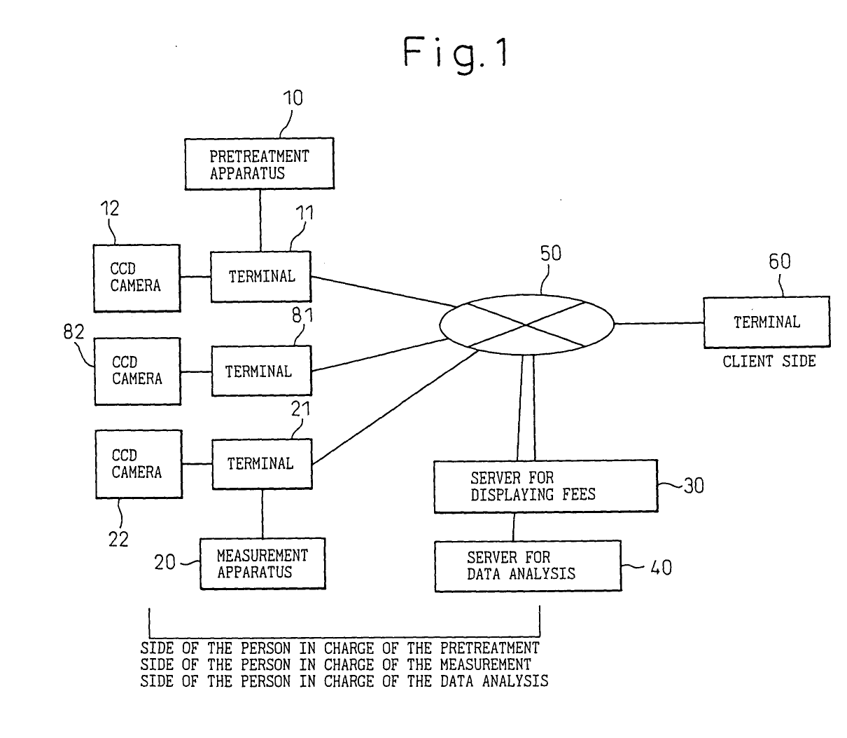

FIG. 1 is a diagram illustrating the constitution of a virtual analytical collaboration system to which the present invention is applied.

A terminal 11 on the side of the pretreatment apparatus is connected to a pretreatment apparatus 10 and to a CCD camera 12. A terminal 21 on the side of the measurement apparatus is connected to the measurement apparatus 20 and to a CCD camera 22. A CCD camera 82 is connected to a terminal 81 on the data analysis side. The CCD cameras referred to here encompass the use of apparatus utilizing CMOS and a photo diode array that receive the image as electrical data. The terminals 11, 21 and 81 are connected to a terminal 60 on the client side through a communication circuit 50 The communication circuit 50 may be a circuit such as a telephone circuit, ISDN, DSL, PHS, CATV, cell phones or satellite communications, or a network such as an internet, LAN, WAN, etc. Multiple data can be displayed on a screen of a display unit by making a connection to plural apparatus, i.e., by making a connection to the communication circuit 50 via an MCU unit or the like unit.

The terminal 11 of the pretreatment apparatus 10 displays on the screen of its display unit, an image output from the pretreatment apparatus 10 and data such as pretreatment conditions. Part or all of the data displayed on the terminal 11 is also displayed in real time on the terminal 60 on the client side through the communication circuit 50. When a computer is incorporated in the pretreatment apparatus 10, the computer may be directly utilized as the terminal 11.

The terminal 21 of the measurement apparatus 20 displays on the screen of its display unit the measured results output from the measurement apparatus 20 and the data such as measurement conditions. Part or all of the data displayed on the terminal 21 is also displayed in real time on the terminal 60 on the client side through the communication circuit 50. Recently, a computer has often been incorporated in the measurement apparatus 20. In such a case, the computer may be directly used as the terminal 21.

The terminal 81 on the data analysis side displays on the screen of its display unit the measured results called from the server 40 for data analysis and the data such as measurement conditions. Part or all of the data displayed on the terminal 81 is also displayed in real time on the terminal 60 on the client side through the communication circuit 50.

FIG. 1 functionally illustrates the virtual analytical collaboration system. Concretely speaking, the elements constituting the system can be arbitrarily combined together or separated from each other. For example, the terminals 11, 21 and 81 need not be separately constituted. Instead, a single terminal may be used in common. Further, the pretreatment apparatus 10 and the measurement apparatus 20 may often be realized as a single unit. The server 30 for displaying the fees and the server 40 for data analysis may be incorporated in the terminal 11, 21 or 81.

The terminals 11, 21 and 81 are connected to the server 30 for displaying the fees and to the server 40 for data analysis via the communication circuit 50. The servers 30 and 40 can be used in common. Their number may be increased depending upon the service that is required.

The server 30 for displaying the fees stores a database of fees per a unit time determined for each of the pretreatment method, measurement method and data analysis method, and fees for each of the data. The terminal 11, 21 or 81 is connected to the terminal 60 on the client side through the communication circuit 50. When the pretreatment, measurement or data analysis starts, automatically displayed are the fees for the data currently displayed, elapse of time of the pretreatment, measurement or data analysis, and the total fees of the past pretreatment, measurement or data analysis on the display screens at the terminal 11, 21 or 81 and on the screen at the terminal 60 on the client side. Here, the fees may be displayed on only the terminal 60 on the client side and need not be displayed on other terminals 11, 21 and 81.

The server 40 for data analysis stores the data analyzing system, the measurement database and the information data base. In response to a call request signal from the terminal 11, 21 or 81, the data are displayed on the terminal 11, 21 or 81. Further, part or all of the display may also be displayed on the terminal 60 on the client side through the communication circuit 50 to forward the data analysis in collaboration.

The pretreatment referred to here means all treatments necessary for conducting the measurement. The concrete contents may vary depending upon the method of measurement that is conducted but may include the following.

Namely, separation treatments such as centrifugal separation, filtration, quick quenching, liquid chromatography, electrophoresis, gas chromatography and thin layer chromatography; extraction treatments such as Soxhlet extraction, liquid-liquid extraction, solid phase extraction, and solid phase micro-extraction; condensation treatments such as centrifugal condensation and the like; decomposition treatments such as heat decomposition, alkali decomposition, acid decomposition, and amine decomposition; drying treatments such as freeze drying, vacuum drying, critical point drying and t-butanol drying; pulverization treatments such as freeze pulverization, ball mill pulverization, jet mill pulverization and mortar pulverization; reprecipitation treatment; dissolution treatment; dilution treatment; heat treatment; derivation treatment; immersion treatment; sublimation treatment; cutting treatments such as cutting and precision cutting; evaporation treatment; distillation treatment; labeling treatment by antibody reaction; dyeing treatment; machining treatments by using a focused ion beam machining apparatus (FIB), a dicing saw, a laser machining apparatus, an ultrasonic wave machining apparatus, ion milling, microtome, electron ray machining, and discharge machining; cutting treatments based upon dissolving method, polishing method, micro-manipulator, high-frequency heating, sputtering, any other general cutting, and freeze cutting; polishing treatments such as machine polishing, ionic polishing, rotary polishing, chemical polishing and electrolytic polishing; etching treatments such as chemical etching, ion etching and chemical etching; fixing treatment for fixing the sample; dehydration treatment; packaging, package-removing treatment; vacuum evaporation treatments such as metal evaporation and carbon evaporation; sputter-coating treatment; piece-forming treatments such as forming very thin pieces and frozen pieces; replica treatment for forming a replica for a transmission-type electron microscope; and dispersion treatment.

Some of the examples will be described in detail. The section of the sample may be observed by using an electron microscope, or the section of the sample may be measured by using an energy dispersed X-ray analyzer (EDX), Auger electron spectrometer (AES) or secondary ionic mass spectrometer (SIMS). In this case, the cross section of a portion of the sample to be observed or measured is exposed by using the focused ion beam machining apparatus (FIB). Or, a sampling piece including a portion to be observed is prepared by using the microtome, and is observed.

In general, the conditions such as the location size and shape to be worked by the pretreatment are determined in advance by the consultation between the person in charge of the pretreatment and the client in the step of consultation (1) described earlier. Hence, the person in charge of the pretreatment conducts the processing under the thus determined conditions.

The pretreatment apparatus 10 includes those that can be called apparatus, such as a laser machining device, a micro-manipulator, a manipulator, a microtome, a focused ion beam machining device (FIB) and an ion etching device, as well as those utensils such as a knife, a cutter, a probe, a pair of tweezers, a pair of scissors, a rule, etc.

In the case of the pretreatment apparatus having a function for receiving, as electric signals, the data of the place to be worked and of the image of the situations of the pretreatment, the electric signals can be displayed on the terminal 11 by a method that will be described later. In other cases, i.e., when such utensils as a knife, a cutter, a probe, a pair of tweezers and a rule are used, no means is provided for receiving the electric signals representing the place for being machined or a picture of a situation of the pretreatment. In this case, therefore, the CCD camera 12 must be provided.

The measurement apparatus 20 may include any type of measurement apparatus, such as infrared-ray spectrometer, micro-infrared-ray spectrometer, visible light spectrometer, nuclear magnetic resonance spectrometer, Raman spectrometer, micro-Raman spectrometer, visible light spectrometer, ultraviolet-ray spectrometer, gas chromatograph, gas chromatography/mass spectrometer, electrophoretic chromatograph, liquid chromatograph, gel permeation chromatograph, photoelectron spectrometer, Auger electron spectrometer, electron probe microanalyzer, secondary ion mass spectrometer, time of flight secondary ion mass spectrometer, Rutherford back scattering spectrometer, X-ray diffractometer, X-ray fluorescent spectrometer, glazing incident X-ray diffractometer, characteristic X-ray analysis, X-ray reflectometer, scanning probe microscope, transmission electron microscope, electron diffractometer, electron energy loss spectrometer, scanning electron microscope, laser microscope, laser fluorescent microscope, scanning ion microscope, optical microscope, induced coupled plazma masspectrometer, and atomic absorbance spectrometer. When the measurement apparatus is the one that displays an image, spectral data or numerical data, employment of the present invention exhibits a great effect.

The CCD cameras 12 and 22 receive the image data related to the place to be worked and the situations of the pretreatment, as electric signals. The electric signals are then fed to a computer and are directly fed to a monitor to display the picture of the place to be worked and of the situation of the pretreatment. The data are further input to the terminals 11 and 21 to display the image on the terminals 11 and 21.

Or, the outputs of the CCD cameras 12 and 22 can be directly input to the terminals 11 and 21. When a very small region is to be pretreated or machined, the CCD cameras 12 and 22 may be attached to a microscope to obtain an image on an enlarged scale and to display it at the terminals 11 and 21.

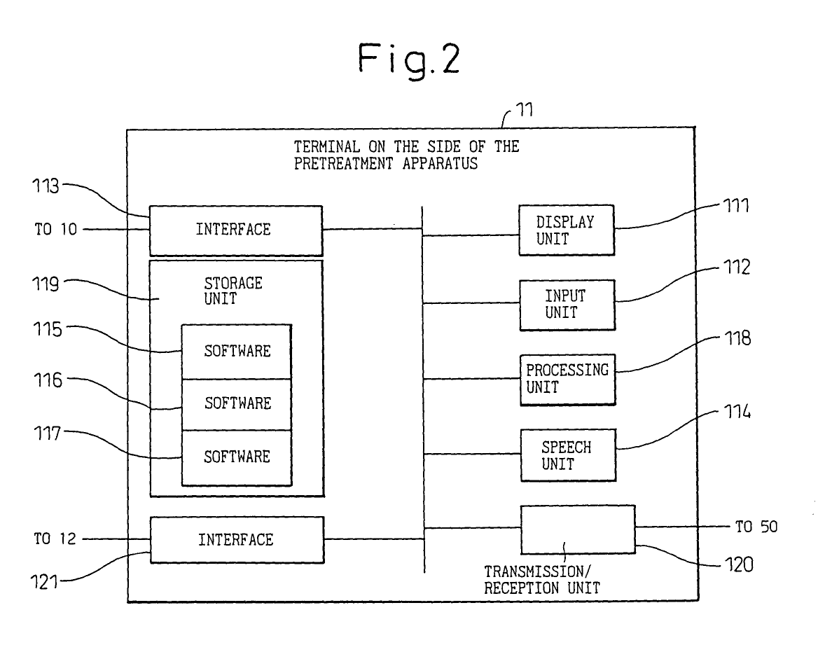

FIG. 2 is a diagram illustrating the constitution of the terminal 11 on the side of the pretreatment 13 apparatus.

The terminal 11 is constituted by a display unit 111, an input unit 112, interfaces 113 and 121, a speech unit 114, a processing unit 118, a storage unit 119, and a transmitter/receiver unit 120.

The display unit 111 works as a user interface and displays the data related to the results of pretreatment and the pretreatment conditions from the pretreatment apparatus 10. When there exist plural pretreatment apparatus or plural terminals 60 on the client side, the display unit 111 displays plural images of the pretreatment simultaneously.

The input unit 112 is used for inputting a variety kinds of commands and for operating the pointers used for indicating the pretreatment conditions. The interface 113 receives the data related to the results of pretreatment and the pretreatment conditions from the pretreatment apparatus 10.

The interface 121 is connected to the CCD camera 12 and processes the image data such as conditions of the pretreatment. The speech unit 114 is used for discussing the results of pretreatment and for instructing and communicating the pretreatment conditions between the person in charge of the pretreatment and the client. The processing unit 118 executes a variety of processes, such as execution of software.

The storage unit 119 stores the software and preserves necessary data. The storage unit 119 further stores a software 115 that receives data from the pretreatment apparatus 10 and displays the data, a software 116 that transmits part or all of the picture displayed on the display unit 111 to the terminal 60 on the client side, and a software 117 for indicating a pointer on the displayed image.

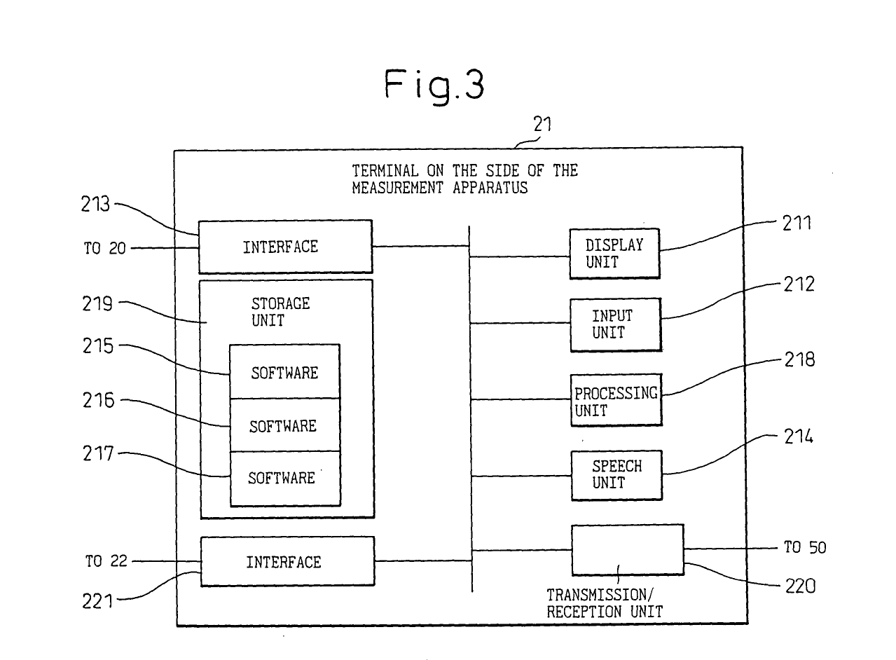

FIG. 3 is a diagram illustrating the constitution of the terminal 21 on the side of the measurement apparatus.

The terminal 21 is constituted by a display unit 211, an input unit 212, interfaces 213 and 221, a speech unit 214, a processing unit 218, a storage unit 219, and a transmission/reception unit 220.

The display unit 211 works as a user interface, and displays the results of measurement and the measurement conditions from the measurement apparatus 20. When there are plural measurement apparatus 20 or plural terminals 60 on the client side, plural images of measurement data are simultaneously displayed on the display unit 211.

The input unit 212 is used for inputting a variety of kinds of commands and for operating the pointer for indicating measurement conditions.

The interface 213 receives the data such as the results of measurement and measurement conditions from the measurement apparatus 20. The interface 221 is connected to a CCD camera 22 to process the image data such as situation of measurement. The speech unit 214 is used for discussing the results of measurement and for instructing and communicating the measurement conditions between the person in charge of the measurement and the client. The processing unit 218 executes a variety of processings such as execution of software.

The storage unit 219 stores the software and saves the necessary data. The storage unit 219 further stores software 215 that receives data from the measurement apparatus 20 and displays the data, software 216 that transmits part or whole of the image displayed on the display unit 211 to the terminal 60 on the client side, and software 217 for indicating a pointer on the displayed picture.

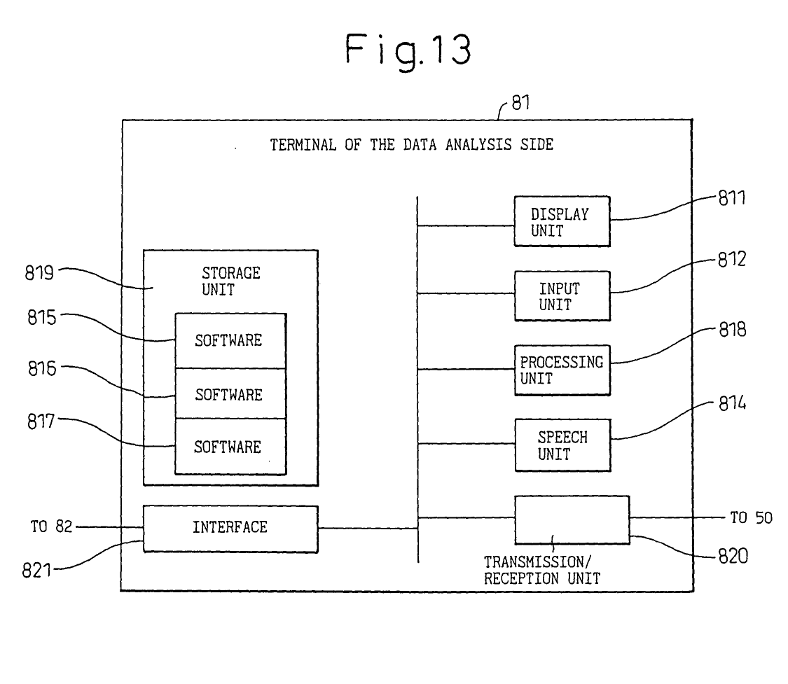

FIG. 13 is a diagram illustrating the constitution of the terminal 81 on the data analysis side.

The terminal 81 is constituted by a display unit 811, an input unit 812, an interface 821, a speech unit 814, a processing unit 818, a storage unit 819, and a transmission/reception unit 820.

The display unit 811 works as a user interface and displays the data such as the results of measurement, measurement conditions and results of data analysis from the server 40 for data analysis. When there are plural terminals 60 on the client side, the display unit 811 simultaneously displays plural images of analytical data.

The input unit 812 is used for inputting a variety kinds of commands and for operating a pointer for indicating the data measurement conditions.

The transmission/reception unit 820 receives the data such as the results of measurement and the measurement conditions from the server 40 for data analysis. The interface 821 is connected to the CCD camera 82 to process the image data such as the situation of data analysis. The speech unit 814 is used for discussing the results of measurement and for instructing and communicating measurement conditions between the person in charge of the data analysis and the client. The processing unit 818 executes a variety of processings such as the execution of software.

The storage unit 819 stores the software and saves necessary data. The storage unit 819 further stores software 815 that receives data from the sever 40 for data analysis and displays the data, software 816 that transmits part or all of the image displayed on the display unit 811 to the terminal 60 on the client side, and software 817 for indicating a pointer on the displayed image.

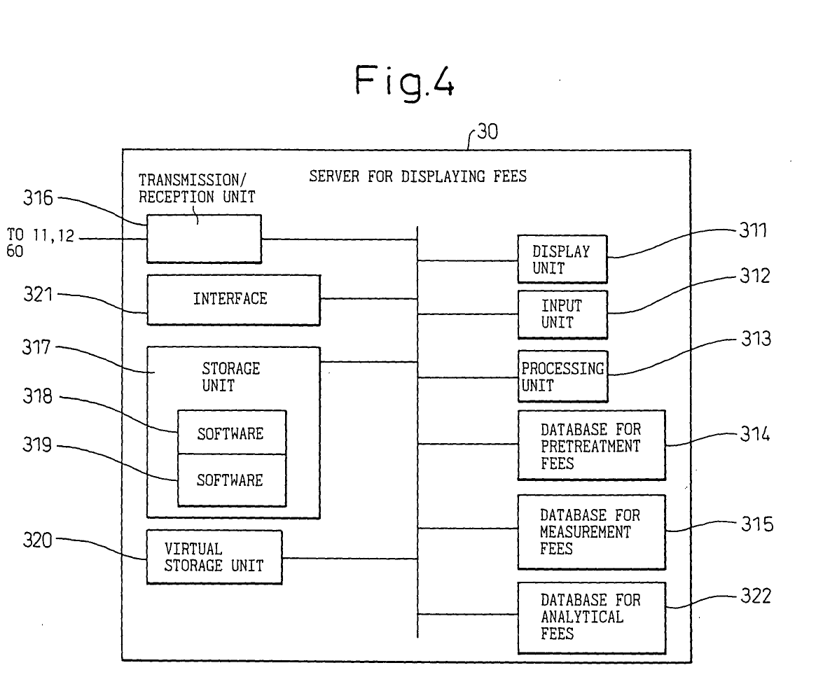

FIG. 4 is a diagram illustrating the constitution of the server 30 for displaying the fees.

The server 30 includes a display unit 311, an input unit 312, a processing unit 313, a storage unit 317, a virtual storage unit 320, a database 314 for the pretreatment fees, a database 315 for the measurement fees, a database 322 for the data analysis fees, an interface 321, and transmission/reception unit 316.

The server 30 receives, through the transmission/reception unit 316, the signals transmitted from the terminals 11, 21, 81 and the terminal 60 on the client side via the communication circuit 50, executes a predetermined processing in the processing unit 313 through the interface 321 and, as required, sends the signals to the storage unit 317 and to the virtual storage unit 320 through the interface 321.

In the server 30, the database 314 for the pretreatment fees stores a pretreatment fee system, the database 315 for the measurement fees stores an measurement fee system, and the database 322 for the data analysis fees stores a data analysis fee system. In these systems, the fees have been determined in advance for each of the pretreatment apparatus and the measurement apparatus depending upon the time of use and the kind of data.

The terminal 11, 21 or 81 is connected to the terminal 60 on the client side through the communication circuit 50, and the pretreatment, measurement or data analysis starts. Then, the sum of fees incurred thus far is displayed on the terminals 11, 21, 81 and 60 simultaneously based on the time required for the pretreatment, for the measurement or for the data analysis, and on the data transmitted to the client from the person in charge of the pretreatment, from the person in charge of the measurement or from the person in charge of the data analysis.

At the same time, the fees for obtaining the data displayed on the screen can also be displayed on the screen. Further, the elapse of time for the pretreatment, measurement or data analysis can also be displayed. As required, further, charges and fees can be changed and modified in response to a request signal from the terminal 11 on the side of the pretreatment apparatus, from the terminal 21 on the side of the measurement apparatus or from the terminal 81 on the data analysis side.

When there are plural terminals 11 on the side of the pretreatment apparatus, plural terminals 21 on the side of the measurement apparatus, plural terminals 81 on the data analysis side or plural terminals 60 on the client side, there is provided a virtual storage unit 320 that can be connected to plural transmitter/receiver units, so that virtual analytical collaboration work can be carried out while looking at plural images on the display unit 311.

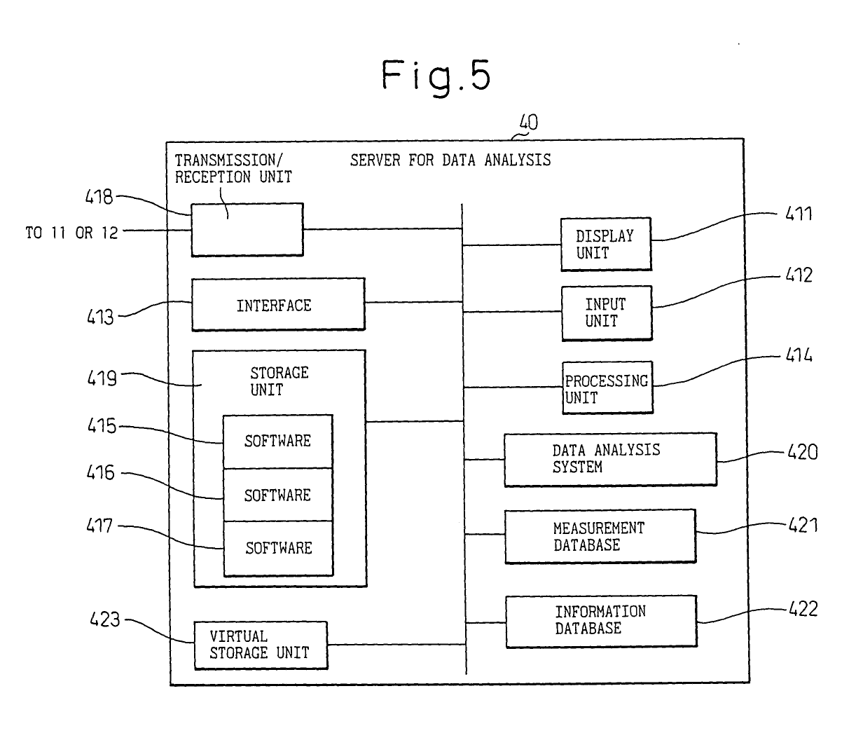

FIG. 5 is a diagram illustrating the constitution of the server 40 for data analysis.

The server 40 includes a display unit 411, an input unit 412, an interface 413, a processing unit 414, a storage unit 419, a virtual storage unit 423, a transmitter/receiver unit 418, a data analyzing system 420 using various softwares for analyzing the measured data, a measurement database 421 comprising spectra and numerical data of various materials, and an information database 422. The storage unit 419 stores various softwares 415, 416 and 417.

The data analysis system 420 may be, for example, an infrared-ray absorption spectral data analysis system, a nuclear magnetic resonance spectral data analysis system, a Raman spectral data analysis system, a mass spectral data analysis system, a photoelectron spectral data analysis system, an Auger electron spectral data analysis system, a secondary ion mass spectral data analysis system, time of flight secondary ion mass analytical spectral data analysis system, an X-ray diffraction data analysis system, a crystalline structure analysis system, a X-ray fluorescent data analysis system, a scanning-type probe microscope data analysis system, a surface state data analysis system, a various-picture-data analysis system, a data analysis system for various statistic processings such as multivariate analysis, and a numerical/graphic data analysis system.

The diagrammed data analysis system 420 uses a system that can be utilized on a network. It is, however, also allowable to use an application program for data analysis system attached to the measurement apparatus 20 and an additional data analysis system.

By utilizing the above data analysis system 420, the client and the person in charge of the data analysis are allowed to totally analyze in collaboration the qualitative data, quantitative data, composition, chemical state, crystalline structure, surface state, physical properties and statistically processed data of substances relying upon the obtained spectra, images and numerical data.

In this case, some data analysis systems that can be utilized are displayed on their own screens so as to be selected by being clicked. It is desired that the data analysis system has a tree structure which is successively branched into smaller groups from a large group from the standpoint of smoothly carrying out the data analysis.

Further, each group of data to be studied should desirably be displayed on its own screen when a required analytical database is selected so as to be selected by being clicked and quickly analyzed. It is desired that the data group have a tree structure which is successively branched into smaller groups from a large group from the standpoint of smoothly carrying out the analysis.

The measurement database 421 may be, for example, an infrared absorption spectral database, a nuclear magnetic resonance spectral database, a Raman spectral database, a mass spectral database, a photoelectron spectral database, an Auger electron spectral database, a secondary ion mass spectral database, a time of flight secondary ion mass spectral database, an X-ray diffraction database, a X-ray fluorescent database, a scanning probe microscope database, a transmission-type electron microscope picture database, a scanning microscope picture database, or an optical microscope picture database.

The diagrammed measurement database 421 uses a system that can be utilized on a network. It is, however, also allowable to use the database attached to the measurement apparatus 20 or an additional database. Here, the additional database is obtained by measuring a new material or under new conditions, and stands for those data that are added sequentially. The data that are accumulated assist in correctly and quickly obtaining the results in case there occurs a new analytical problem.

Data analysis systems and measurement databases made available on the Internet also can be utilized as data analysis databases.

In this case, each measurement database that can be utilized is displayed on its own screen so as to be selected by being clicked. It is desired that the measurement database has a tree structure which is successively branched into smaller groups from a large group from the standpoint of smoothly carrying out the data analysis.

Desirably, further, a storage unit is provided for storing the analyzed results and, as required, the analyzed results and the data selected from the stored data are displayed on their own screens so that they can be studied in comparison.

The information database 422 includes, for example, the measured results, reports and articles for measurement method, the method of pretreating the samples, the analysis of various troubles, and various materials. It is desired that the data can be easily referred to by title search, by keyword search, by a human name search, by chronological search, by organization search or by full text search.

The diagrammed information database 422 can be used on a network. However, there may be used an information database that is prepared by the person in charge of the pretreatment, by the person in charge of the measurement, by the person in charge of the data analysis or by the client.

In this case, it is desired that each information database that can be utilized is displayed on its own screen and can be selected upon being clicked from the standpoint of smoothly forwarding the data analysis. It is desired that the information database has a tree structure which is successively branched into smaller groups from a large group from the standpoint of smoothly carrying out the analysis.

The server 40 receives, through the transmission/reception unit 418, the signals sent from the terminal 11, 21, 81 or 60 via the communication circuit 50, executes a predetermined processing in the processing unit 414 through the interface 413 and, as required, sends signals to the storage unit 419 and to the virtual storage unit 423 through the interface 413.

When there are plural terminals 11 on the side of the pretreatment apparatus, plural terminals 21 on the side of the measurement apparatus, plural terminals 81 on the data analysis side or plural terminals 60 on the client side, there is provided a virtual storage unit 423 that can be connected to plural transmitter/receiver units, so that virtual analytical collaboration work can be carried out while looking at plural images on the display unit 411.

The transmission/reception unit 418 connects the server 40 to the communication circuit 50. Required data are obtained by making a connection in response to a data request signal from the terminal on the side of the pretreatment apparatus, from the terminal 21 on the side of the measurement apparatus, from the terminal 81 on the data analysis side or from the terminal 60 from the client side.

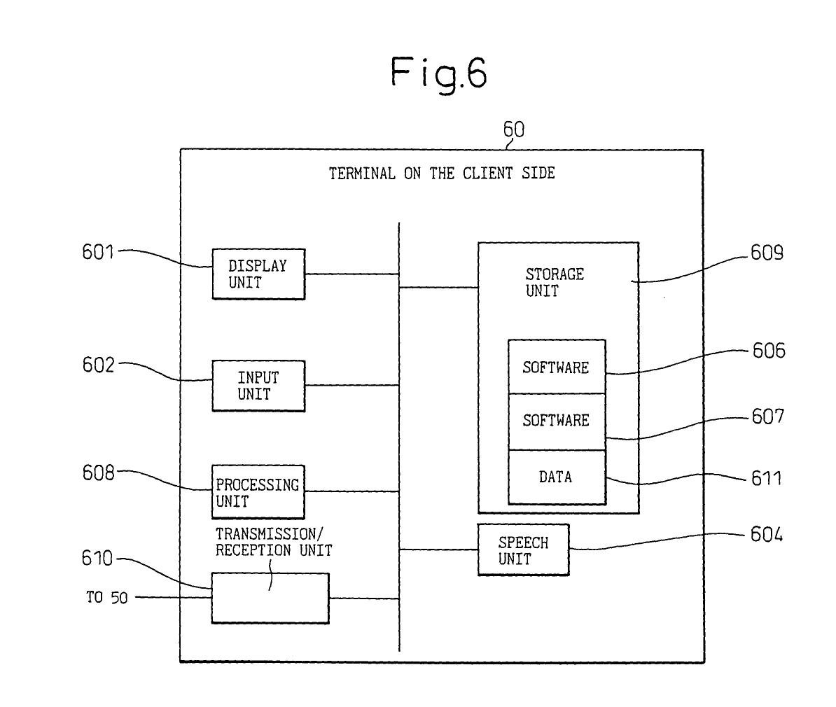

FIG. 6 is a diagram illustrating the constitution of the terminal 60 on the client side.

The terminal 60 is constituted by a display unit 601, an input unit 602, a speech unit 604, a processing unit 608, a storage unit 69 and a transmitter/receiver unit 610.

The display unit 601 displays part or all of the picture on the display unit 111, 211 or 811 of the terminal 11, 21 or 81. The input unit 602 is used for inputting various commands and for operating the pointer for instructing the measurement conditions.

The speech unit 604 is used for discussing the results of measurement and for instructing and communicating measurement conditions among the person in charge of the pretreatment, person in charge of the measurement, person in charge of the data analysis and the client. The processing unit 608 executes various processes such as executing software.

The storage unit 609 stores the software and holds necessary data. The storage unit 609 further stores software 606 which displays the received measurement data on the display unit 601, software 607 for displaying a pointer on the display screen, and the data 611 that are received.

The transmission/reception unit 610 connects the terminal 60 on the client side to the communication circuit 50. The transmission/reception unit 610 can be further connected to a network such as a LAN or WAN through a separate communication circuit, and to other telephone circuits, ISDN, DSL, cell phone, PHS, CATV, and satellite broadcast.

In FIG. 1, the communication circuit 50 is realized by a circuit that connects to the terminal 11, 21, 81 or 60 through a network or a point-to-point connection. As the network, there can be exemplified LAN, WAN and Internet.

As the point-to-point connection, there can be exemplified a telephone circuit, ISDN, DSL, cell phone and PHS. When a network is utilized, a connection to the network can be done by any method which has been generally employed. That is, a direct connection is made to the network by Ethernet or a connection is made through a provider. When the connection passes through the provider, the connection is made to the provider through a general telephone circuit, an IDN circuit, a DSL, a cell phone, a PHS, a CATV or a satellite circuit.

Use of the network makes it possible to simultaneously connect the pretreatment apparatus 10, the measurement apparatus 20, and the terminals 11, 21, 81 and 60. Therefore, the displayed screens of one or plural pretreatment apparatus 10 and measurement apparatus 20 can be displayed on one or plural terminals 60 on the client side.

Referring to FIGS. 2 to 6 and 13, the display units 111, 211, 311, 411, 601 and 811 can be realized by display devices such as CRT, liquid crystal display, etc. The input units 112, 212, 312, 412, 602 and 812 can be realized by a pointing device such as a mouse, a touch panel a track ball, or a keyboard.

The interfaces 113 and 213 can be realized by the one same as the output interface attached to the pretreatment apparatus 10 and to the measured apparatus 20. In the case of the measurement apparatus that produces numerical data or spectral data, there is, in many cases, provided USB, GRIP, HPIB or RS232C. The interfaces, however, can be realized by incorporating the same interface cards as those of the pretreatment apparatus 10 and measurement apparatus 20, and software for controlling them, in the terminals 11 and 21.

In producing the image data, the measurement apparatus is in many cases provided with an interface for composite video signals, S video signals and RGB signals. In these cases, the interfaces can be realized by using a video capture card equipped with input/output terminals therefor. Even in a case where the measurement apparatus 20 is not equipped with these interfaces, the interfaces can be realized by using a video capture card for RGB by taking out the RGB signals that are being sent to the display unit from the main body of the computer when the computer is used at the console terminals of the pretreatment apparatus 10 and the measurement apparatus 20.

The storage units 119, 219, 317, 419, 609 and 819 can be realized by a storage device such as a hard disk. The processing units 118, 218, 313, 414, 608 and 818 can be realized by a CPU or the like.

The transmission/reception units 120, 220, 316, 418, 610 and 820 may differ depending upon the communication circuit that is used. The transmission/reception units can be realized by using an Ethernet card when they are to be connected to the Ethernet, by using a DSU and TA when they are to be connected to ISDN or by using a modem when they are to be connected to a telephone circuit.

As will be obvious from the constitutions of the above-mentioned terminals 11, 21, 81 and 60, the terminals 11 and 21 are, respectively, realized by a computer system incorporating the interfaces 113 and 213, and the terminals 81 and 60 are, respectively, realized by a computer system.

When one or more computer systems are used in the consoles of the pretreatment apparatus 10 and of the measurement apparatus 20, software is installed in these computers, the software having a function to display part or all of the content displayed on the computer screen on the display unit of a terminal at a distance. This enables the measured results displayed on the computer screen which is a console of the measurement apparatus to be taken out from the terminal 60 on the client side.

The speech units 114, 214, 604 and 814 comprise a voice input device and a voice output device. In this embodiment, the communication unit is realized by speech units 114, 214, 604 and 814, and by software 117, 217, 607 and 817. The software 117, 217, 607 and 817 have a function for transmitting the voice input through the voice input device to the terminal of the other party and a function for receiving the voice input through the terminal on the side of the other party and for reproducing the voice through the voice output device. The voice input device will be, for example, a microphone.

The voice reproducing device is realized by a speaker or a headphone. When vibration due to the sound of the speaker hinders the observation of image by using, for example, an electron microscope, a headset or a handset may be used to suppress vibration. Instead of being incorporated in the terminals 11, 21, 60 and 81, further, the speech units 114, 214, 604 and 814 may be replaced by a telephone or a cell phone. As a communication unit, there can be also used a means of character communication such as chatting or electronic mail instead of speech.

Next, described below is the operation of this embodiment.

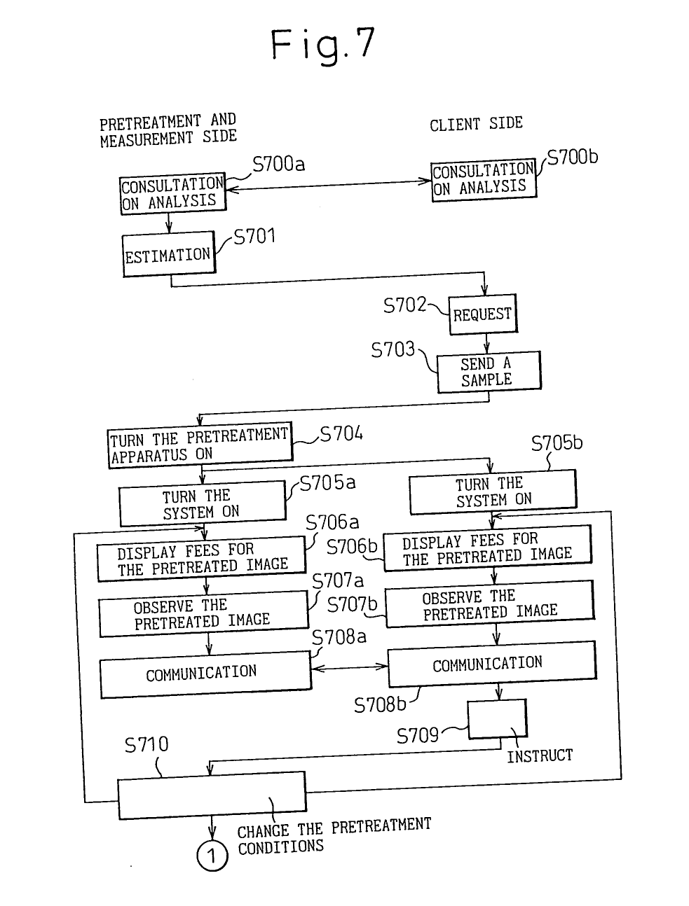

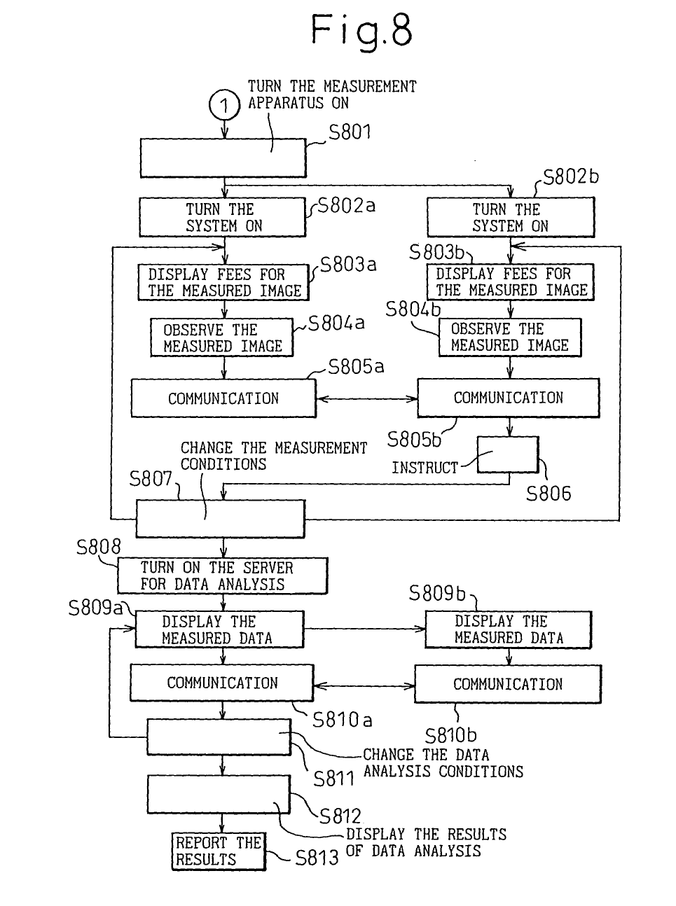

FIGS. 7 and 8 illustrate the flow of this embodiment. In putting this embodiment into practice, first, the person in charge of the consultation or his agent and the client hold a consultation for data analysis to determine what kind of measurement be carried out in advance (S700a, S700b). Next, the person in charge of the consultation prepares an estimate and submits it to the client (S701). When the estimate is within a range of budget, the client requests the job (S702) and has the sample delivered to the person in charge of the consultation (S703).

The above consultation of data analysis S700 to S702 can be conducted by using terminals. Described below is an example of when the consultation of data analysis is carried out by using the terminal 11 on the side of the pretreatment apparatus.

On the day of consultation, the person in charge of the consultation and the client turn their terminals 11 and 60 on. Part or all of the screen displayed on the display unit 111 of the terminal 11 on the side of the person in charge of the consultation is also displayed on the display unit 601 of the terminal 60. The person in charge of the consultation and the client render a decision concerning the method of measurement, number of the samples to be measured, method of pretreating the samples and the form of output of the measured results while making a communication by using the speech devices 114 and 604 by referring to the displayed screen.

At this moment, if connection is made to the server 40 for data analysis in response to a data request signal from the terminal 11 on the side of the person in charge of the consultation or from the terminal 60 on the client side to conduct the analytical design while referring to the data, the analytical design can be optimized, and the data analysis can be effectively conducted even in the subsequent flow.

The above consultation of data analysis can be similarly conducted even by using the terminal 21 on the side of the measurement apparatus or by using the terminal 81 on the data analysis side.

After having received the sample, the person in charge of the pretreatment turns on the terminal 11 and the software 115, 116 and 117 on the day of pretreatment (S705a). At the same time, the client turns on the terminal 60 and the software 606 and 607 (S705b).

When the person in charge of the pretreatment starts the pretreatment, the display unit 111 of the terminal 11 displays the pretreatment conditions, interim results, passage of time of the pretreatment and the fees incurred (S706a). Part or all of the displayed data are also displayed on the display unit 601 of the terminal 60 on the client side (S706b). When the pretreatment apparatus 10 produces signals such as NTSC and RGB and the terminal 11 is taking in the image data through a video capture device, the image showing the situation of the pretreatment is nearly simultaneously displayed on the terminal 60 on the client side.

Here, the word “nearly” is used since the frequency of updating the display is limited by the capacity of the communication circuit 50 and a time lag of several seconds often occurs depending on the cases. Part or all of the image displayed on the display unit 111 at the terminal 11 is also displayed on the display unit 601 at the terminal 60.

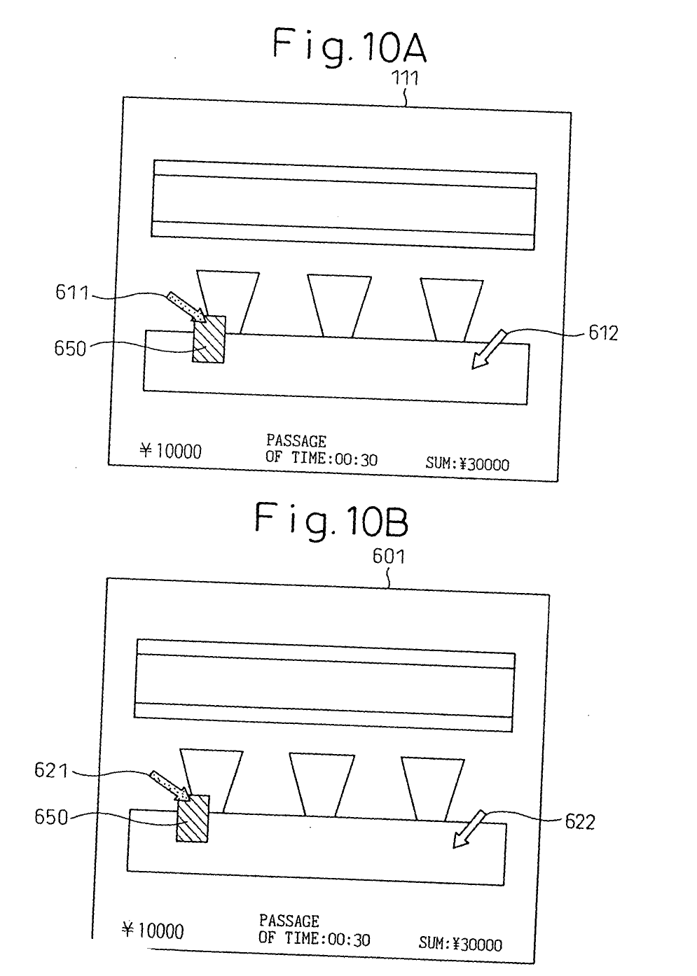

FIGS. 10A and 10B illustrate screens displayed on the display unit 111 on the side of the person in charge of the pretreatment and displayed on the display unit 601 on the side of the client in pretreating the sample having an irregular structure.

Pointers 611, 612, 621 and 622 are displayed on the screens. One pointer displayed on the display unit 111 on the side of the person in charge of the pretreatment is controlled by the person in charge of the pretreatment, and the other pointer 612 is controlled by the client. One pointer 621 displayed on the display unit 501 on the side of the client is controlled by the person in charge of the pretreatment, and the other pointer 622 is controlled by the client. The pointers 611, 621 operated by the person in charge of the pretreatment may be displayed in red color and the pointers 612, 622 operated by the client may be displayed in yellow color to enhance the operability.

The client may indicate a portion 650 which he wants to view in cross section by using the pointers 612, 622, and the person in charge of the pretreatment reliably executes the pretreatment of the necessary portion and views the desired portion in cross section.

The pointers need not necessarily be displayed in real time on the screens. For example, software capable of displaying a still image on both display screens, is turned on at both the terminal 11 on the side of the person in charge of the pretreatment and the terminal 60 on the client side, and the pointers are displayed on both screens. The person in charge of the pretreatment then copies a still image that is to be saved from the screen that is displayed in real time, and the pointer is displayed on this still image. Then, the person in charge of the pretreatment and the client discuss the matter while indicating a portion in dispute by pointing it out using their independent pointers and designating the portion to be pretreated. The operability can be further improved by replacing the indication means from the pointers by rectangular selection tools, by replacing the indication means by circular selection tools, by replacing the colors of the selection tools, or by replacing the tools that are so drawn as can be overlapped on the picture.

The person in charge of the pretreatment and the client communicate with each other (S708a, 708b) while observing the pretreated image (S707a, 707b). Then, if the client issues his next instruction (S709), the person in charge of the pretreatment changes the conditions (S710) based on the instruction. Next, the routine returns back to step S706 to effect the pretreatment again. This loop is repeated to carry out the pretreatment. In this case, the situations of the pretreatment, the passage of time and the fees of the treatment incurred thus far are displayed on the lower portion of the display unit 111 at the terminal 12 and on the lower portion of the display unit 601 at the terminal 60. When the pretreatment is finished, the person in charge of the pretreatment saves the data of pretreatment in the server 40 to end the virtual analytical collaboration work.

Here, as the method of pretreating a very small sample such as FIB, it may become necessary in many cases to highly precisely specify the portion to be worked at steps S707a and S707b. In this case, communication using the speech units only is not enough for precisely specifying the place. According to this embodiment, the pointers 611 and 621 simultaneously displayed on both display units 111 and 501 are operated by the person in charge of the measurement, and the pointers 612 and 622 are operated by the client to efficiently proceed with the measurement while preventing the possibility of portions that need to be measured not being taken into account, or unnecessary portions being measured.

It is further allowable to read the image pattern of the pretreated sample, to specify the measured portion, and to store the data thereof in the server 40 for data analysis. Then, the data of a portion to be measured can be read out from the server 40 at the time when the sample is set to the measurement apparatus, and the portion to be measured can be automatically set to reliably conduct the measurement.

Then, the measurement apparatus 20 is turned on (S801) on the day of conducting the measurement, and the pretreated sample is set in the data analysis apparatus 20. Next, the person in charge of the measurement turns on the terminal 21 and the software 215, 216 and 217 (S802a). At the same time, the client turns on the terminal 60 and the software 606 and 607 (S802b).

When the person in charge of the measurement starts the measurement, the conditions of measurement, interim results, passage of time of the measurement and the fees incurred are displayed on the display unit 211 at the terminal 21 (S803a, S803b). Part or all of the displayed data are also displayed on the display unit 601 at the terminal 60.

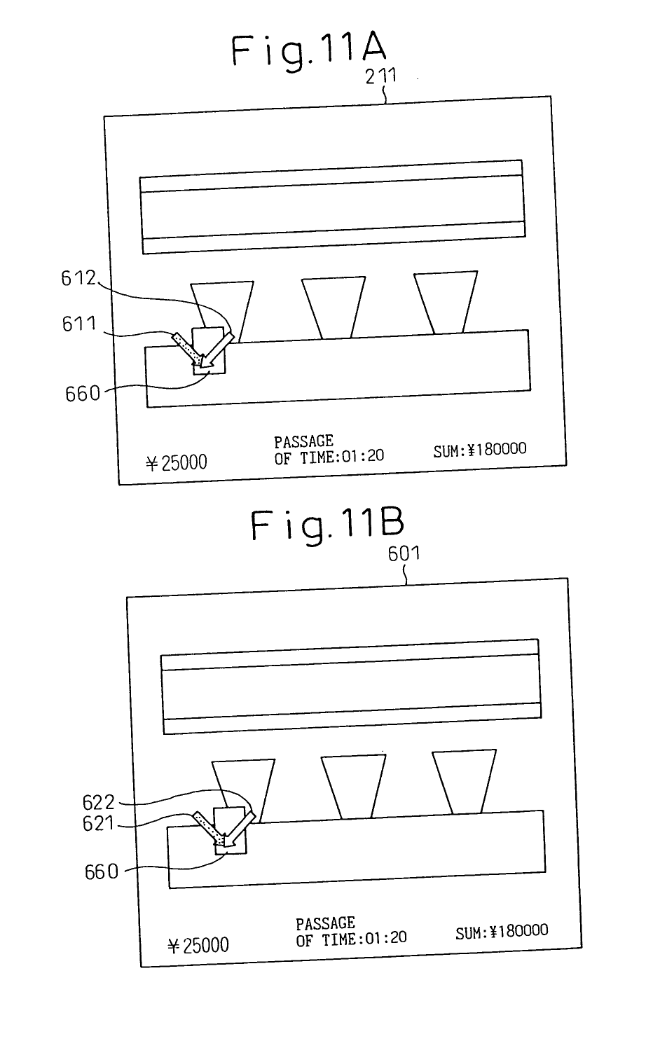

FIGS. 11A and 11B illustrate screens displayed on the display unit 211 on the side of the person in charge of the measurement and displayed on the display unit 601 on the client side.

An image of the results of the measurement is displayed on the display unit 211 on the side of the person in charge of the measurement as shown in FIG. 11A, and an image in agreement therewith is displayed on the display unit 601 on the client side as shown in FIG. 11B. On the screens are displayed the pointers 611 and 621 operated by the person in charge of the measurement as well as the pointers 612 and 622 operated by the client.

The person in charge of the measurement and the client makes the communication (S805a, S805b) while observing the measurement screen (S804a, S804b). When the client issues a next instruction (S806), the person in charge of the measurement changes the conditions based on the instruction (S807). Next, the routine returns back to the steps S803a and S803b to carry out the measurement again. The loop is repeated to carry out the measurement.

In this case, the data and image of measurement, passage of time of measurement and the fees of measurement incurred thus far are displayed on a lower portion of the display unit 211 at the terminal 20 and on a lower portion of the display unit 601 at the terminal 60. While looking at the screen, therefore, the client may render a judgement not to conduct an unnecessary measurement. After the measurement has been finished, the person in charge of the measurement saves the measurement data in the server 40 for data analysis to end the virtual analytical collaboration work.

In measuring chiefly consisting of the observation image or in measuring contaminant, in many cases it becomes important to specify places to be measured at steps S804a and S804b. In this case, the communication relying on the voice communication only is not enough for correctly specifying the place. According to this embodiment, the pointers 611 and 621 simultaneously displayed on both display units 111 and 501 are operated by the person in charge of the measurement, and the pointers 612 and 622 are operated by the client to efficiently proceed with the measurement preventing the possibility of portions that need to be measured not being taken into account or unnecessary portions being measured.

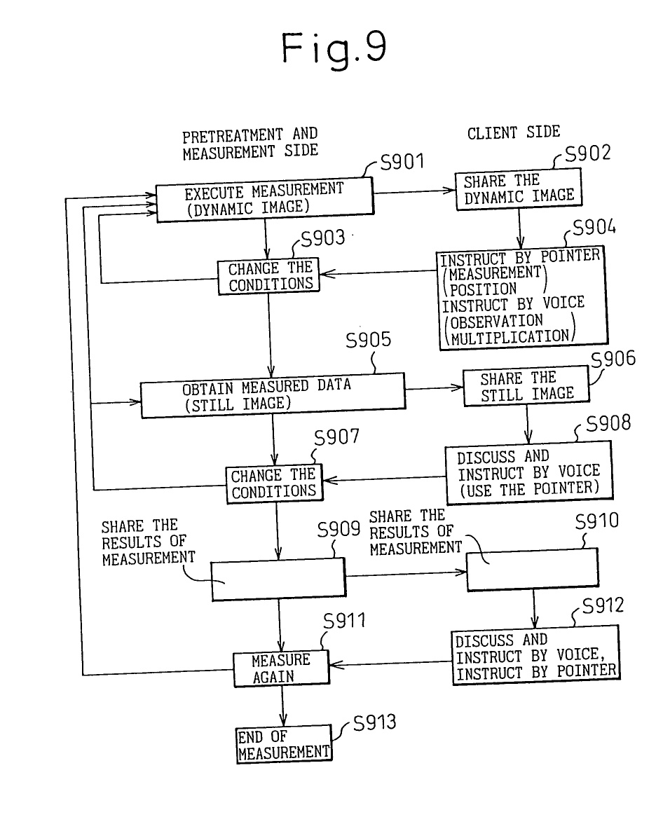

A communication process (805a, 805b) at the time of executing the measurement will now be described in further detail with reference to FIG. 9.

The person in charge of the measurement conducts the measurement by using the measurement apparatus 20; i.e., a real time video is displayed on the display unit 211 at the terminal 21 (S901), and part or all thereof is also displayed on the display unit 601 at the terminal 60 (S902). The person in charge of the measurement and the client conduct the measurement (S904) by also utilizing communication by voice while indicating a portion of the sample to be measured on the real time video by using the pointers. If necessary, the client instructs the person in charge of the measurement to change the conditions, and the person in charge of the measurement carries this out (S903).

Then, the person in charge of the measurement obtains the data maintaining high precision, high quality and high resolution as still image (S905) based on the results of communication using the real time video. The still image is once obtained by the person in charge of the measurement and is, at the same time, sent to the client or is sent to the client after being saved in the terminal 21 or in the server 40 for data analysis (S906). In this case, it may often become necessary to transmit data in large quantities. By taking the bandwith into consideration, therefore, it is desired to allocate wider bandwidth band communication for transmitting a still image.

In measuring the still image that was once saved, when no voice is input for a certain period of time, then, the band width can be automatically changed. The still image is further closely studied (S908) between the person in charge of the measurement and the client by utilizing the voice and the pointers. When it is desired to conduct the measurement, the client instructs the person in charge of the measurement to change the conditions of measurement judging from the results of the still image (S907).

The finally obtained results of measurement are shared by the display unit 211 at the terminal 21 of the person in charge of the measurement and by the display unit 601 at the terminal 60 of the client (S909, S910), and the conditions of outputs are finally determined. As required, further, the client issues an instruction (S912), and the person in charge of the measurement takes the measurement again (S911). Further, the fees for the measurement can be confirmed at the same time. When everything has finished, the person in charge of the measurement transmits the data of measurement to the client to end the measurement (S913).

Here, it needs not be pointed out that the same process can be employed even for the pretreatment and for the data analysis of the measured results.

Next, the person in charge of the data analysis turns on the terminal 81 on the data analysis side and the server 40 for data analysis, and analyzes the measured results in collaboration with the client (S808).

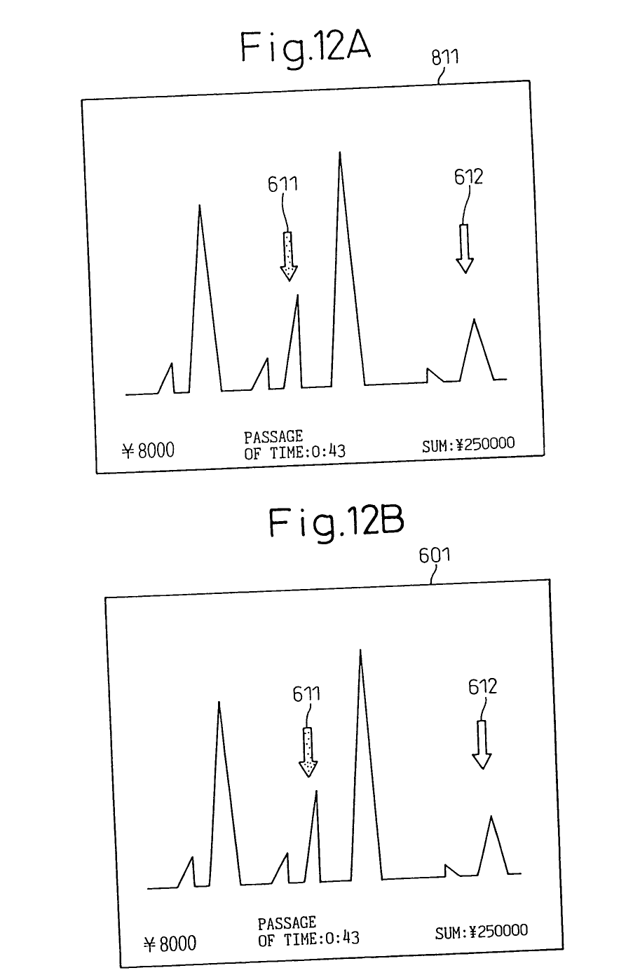

FIGS. 12A and 12B illustrate data that are obtained by measurement and are desired to be analyzed, and illustrate the results obtained by measuring the sample having a complex structure. Referring to FIGS. 12A and 12B, the client indicates, by using the pointers 612 and 622, a peak portion in the spectra which he wishes to have analyzed. The person in charge of the data analysis can then qualitatively measurement the structure of a portion to which attention has been given or data analysis the measured results of composition without any mistake (S809a, S809b).

When the structure is to be identified, the spectra obtained as shown in FIGS. 12A and 12B are analyzed by making a connection to the system 420 for analyzing various data in the server 40 for data analysis in response to a data request signal from the terminal 81 on the data analysis side or from the terminal 60 on the client side. Software required for data analysis is selected from the data analysis system 420, and the portion to which the attention has been given is analyzed.

The results of data analysis are simultaneously displayed on both display units 811 and 601, and the results are discussed by the person in charge of the data analysis and by the client while carrying out communication between them (S810a, S810b). If desired, the data are analyzed by using different parameters, or different portions are analyzed to proceed with the work in collaboration (S811).

In analyzing the data by making reference to the spectra obtained as shown in FIGS. 12A and 12B, further, it may often become difficult to discuss the matter unless the matter is indicated by using pointers like when one peak is an issue among many peaks. In such a case, too, the pointers 611 to 622 can be displayed by the same method as shown in FIGS. 12A and 12B.

It is further allowable to display the results obtained by the data analysis system 420 on the screens of both the person in charge of the data analysis and the client to forward the data analysis in collaboration together while communicating by using an indication means such as pointers or a character input system that can be used by both of them.

By using the above data analysis system 420, it is possible to conduct identification, determination, quantitation, chemical state analysis, distribution analysis, crystal structure analysis, statistic analysis and image analysis.

In analyzing the results of measurement, further, reference is made to the data accumulated thus far and to the data related to various kinds of measurements, in order to efficiently and quickly conduct the data analysis. For this purpose, the person in charge of the data analysis or the client receives a data request signal from the terminals 81 and 60, and makes a connection to the measurement database 421 or to the information database 422 in the server 40 for data analysis.

The person in charge of the data analysis or the client retrieves the database while consulting with each other to obtain necessary data. The obtained results and the results obtained by the data analysis by using the data analysis system and, as required, the results of measurement, are all and simultaneously displayed on both display units 811 and 601. The displayed data can be analyzed by the person in charge of the data analysis and by the client in collaboration together while communicating by using an indication means such as the pointers 611 to 622 or a character input system that can be independently operated by both of them.

As required, data analysis is conducted again by using the data analysis system, and reference is made repetitively to the measurement database or to the information database (S811) to obtain desired results of data analysis. After all of the data analysis has been finished, the person in charge of the data analysis informs the client of the results (S813) to end the virtual analytical collaboration work.

According to the embodiment described above, the client does not have to move to a place where the measurement apparatus 20 is installed unlike the conventional analytical collaboration system. Therefore, the client is allowed to reduce expenses for the movement and to save the time. The client needs attend only for periods of time for instructing the mode of conducting the measurement and for discussing the matter with the person in charge of the measurement, and is allowed to use his time efficiently. To obtain necessary conclusion by analyzing the measured results, further, an expert of measurement and the client having profound knowledge concerning the object to be measured forward the data analysis in collaboration together, so that highly reliable results are obtained.

As described above by way of an embodiment, the present invention makes it possible to automatically settle the charges incurred in the consultation of data analysis, pretreatment, measurement and data analysis through a communication circuit 50.

The settling method may be either payment by an electronic settling method or by an ordinary method of issuing a debit note. After the consultation of data analysis through up to the data analysis have been finished, the sum of fees incurred thus far is displayed on the terminal 60 on the client side. In the case of the electronic settlement, the client makes sure the fees that are displayed and executes a predetermined operation for authorization on the input unit 602 at the terminal 60. Then, the data necessary for the charging are transmitted to a credit settling server, a prepaid setting server, or to a bank settling server through a relay service center connected to the communication circuit 50, and the processing for settlement is executed.

The charge processing can also be effected for each of the consultation of data analysis, the pretreatment, the measurement and the data analysis.

According to the present invention described above, the virtual analysis which is an ideal form of analysis requested by the client, is executed from a distance enabling the client and the persons in charge to discuss the pretreatment of the sample, measurement and data analysis of data in real time to properly determine the direction of processing at all times, preventing delay in the due term caused by wasteful processing, charging of excessive fees, failure to conduct necessary processing and, as a result, making it possible to quickly and efficiently conduct the processing to meet the client's needs.

According to the present invention, further, fees incurred in the services of pretreatment, measurement and in obtaining the measured results, are also displayed in real time, preventing the execution of wasteful pretreatment, measurement and data analysis, and executing only those processings that are really required by the client to meet the client's needs.

1. A virtual pretreatment, measurement and data analysis collaboration system comprising:
a pretreatment apparatus;
a terminal on the side of the pretreatment apparatus having a display unit for displaying pretreatment data obtained from said pretreatment apparatus on a screen, a transmission/reception unit for transmitting part or all of the pretreatment data to a terminal on the client side, a communication unit for communicating with the client, and means for displaying, on said screen, its own indication means and indication means of the terminal on the client side;
a measurement apparatus;
a terminal on the side of the measurement apparatus having a display unit for displaying measured data obtained from said measurement apparatus on a screen, a transmission/reception unit for transmitting part or all of the measured data to the terminal on the client side, a communication unit for communicating with the client side, and means for displaying, on said screen, its own indication means and indication means of the terminal on the client side;
a terminal for data analysis having a display unit for displaying analytical data obtained by the data analysis of the measured results on a screen, a transmission/reception unit for transmitting part or all of the analytical data to the terminal on the client side, a communication unit for communicating with the client, and means for displaying, on said screen, its own indication means and indication means of the terminal on the client side;
the terminal on the client side having a display unit for displaying, on a screen, pretreatment data received from said terminal on the side of the pretreatment apparatus, measured data received from said terminal on the side of the measurement apparatus, or analytical data received from said terminal on the data analysis side, a communication unit for communicating with the side of the pretreatment apparatus, with the side of the measurement apparatus or with the data analysis side, and means for displaying, on said screen, its own indication means and indication means of the terminal on the side of the pretreatment apparatus, of the terminal on the side of the measurement apparatus or of the terminal on the data analysis side; and
a server for data analysis storing software for having the terminal on the data analysis side execute the data analysis and for storing the measured data.

2. A system according to claim 1, further comprising a server for displaying fees, which calculates fees incurred in the pretreatment, fees incurred in the measurement or fees incurred in the data analysis, and which displays the fees on the screen at the terminal on the client side together with the pretreatment data, measurement data or analytical data.

3. A system according to claim 1 or 2, wherein said display unit displays plural pretreatment data, plural measurement data or plural data analysis data simultaneously on the screen.

4. A virtual pretreatment and measurement collaboration system comprising:
a pretreatment apparatus;
a terminal on the side of the pretreatment apparatus having a display unit for displaying pretreatment data obtained from said pretreatment apparatus on a screen, a transmission/reception unit for transmitting part or all of the pretreatment data to a terminal on the client side, a communication unit for communicating with the client side, and means for displaying, on said screen, its own indication means and indication means of the terminal on the client side;
an measurement apparatus;
a terminal on the side of the measurement apparatus having a display unit for displaying measurement data obtained from said measurement apparatus on a screen, a transmission/reception unit for transmitting part or all of the measured data to the terminal on the client side, a communication unit for communicating with the client side, and means for displaying, on said screen, its own indication means and indication means of the terminal on the client side; and
the terminal on the client side having a display unit for displaying, on a screen, pretreatment data received from said terminal on the side of the pretreatment apparatus or measured data received from said terminal on the side of the measurement apparatus, a communication unit for communicating with the side of the pretreatment apparatus or with the side of the measurement apparatus, and indication means for indicating, on said screen, its own indication means and indication means of the terminal on the side of the pretreatment apparatus or of the terminal on the side of the measurement apparatus.

5. A system according to claim 4, further comprising a server for displaying fees, which calculates the fees incurred in the pretreatment or fees incurred in the measurement, and which displays the fees on the screen at the terminal on the client side together with the pretreatment data or measured data.

6. A system according to claim 4 or 5, wherein said display unit displays plural pretreatment data or plural measured data simultaneously on the screen.

7. A system according to any one of claims 1 to 6, wherein the terminal on the side of the measurement apparatus transmits electronic data obtained by the measurement to the client side through a communication circuit.

8. A virtual pretreatment collaboration system comprising:
a pretreatment apparatus;
a terminal on the side of the pretreatment apparatus having a display unit for displaying pretreatment data obtained from said pretreatment apparatus on a screen, a transmission/reception unit for transmitting part or all of the pretreatment data to a terminal on the client side, a communication unit for communicating with the client side, and means for displaying, on said screen, its own indication means and indication means of the terminal on the client side; and
the terminal on the client side having a display unit for displaying, on a screen, pretreatment data received from said terminal on the side of the pretreatment apparatus, a communication unit for communicating with the side of the pretreatment apparatus, and means for indicating, on said screen, its own indication means and indication means of the terminal on the side of the pretreatment apparatus.

9. A system according to claim 8, wherein said display unit displays plural pretreatment data simultaneously on the screen.

10. A system according to claim 8 or 9, further comprising a server for displaying fees, which calculates the fees incurred in the pretreatment, and which displays the fees on the screen at the terminal on the client side together with the pretreatment data.

11. A virtual measurement collaboration system comprising:
an measurement apparatus;
a terminal on the side of the measurement apparatus having a display unit for displaying measured data obtained from said measurement apparatus on a screen, a transmission/reception unit for transmitting part or all of the measured data to a terminal on the client side, a communication unit for communicating with the client side, and means for displaying, on said screen, its own indication means and indication means of the terminal on the client side; and
the terminal on the client side having a display unit for displaying, on a screen, measured data received from said terminal on the side of the measurement apparatus, a communication unit for communicating with the side of the measurement apparatus, and means for displaying, on said screen, its own indication means and indication means of the terminal on the side of the measurement apparatus.

12. A system according to claim 11, wherein said display unit displays plural measured data simultaneously on the screen.

13. A system according to claim 11 or 12, further comprising a server for displaying fees, which calculates the fees incurred in the measurement, and which displays the fees on the screen at the terminal on the client side together with the measured data.

14. A system according to any one of claims 11 to 13, wherein said terminal on the side of the measurement apparatus transmits electronic data obtained by the measurement to the client side via a communication circuit.

15. A virtual analytical collaboration system comprising:
a terminal for data analysis having a display unit for displaying analytical data obtained by the data analysis of the measured results on a screen, a transmission/reception unit for transmitting part or all of the analytical data to a terminal on the client side, a communication unit for communicating with the client, and means for displaying, on said screen, its own indication means and indication means of the terminal on the client side; and
the terminal on the client side having a display unit for displaying, on a screen, analytical data received from said terminal for data analysis, a communication unit for communicating with the data analysis side, and means for displaying, on said screen, its own indication means and indication means of the terminal on the data analysis side.

16. A system according to claim 15, wherein said display unit displays plural analytical data simultaneously on the screen.

17. A system according to claim 15 or 16, further comprising a server for displaying fees, which calculates the fees incurred in the data analysis, and which displays the fees on the screen at the terminal on the client side together with the analytical data.

18. A system according to any one of claims 15 to 17, wherein said terminal on the data analysis side makes an access to at least one of a data analytical system, an measurement database and an information database.

19. A system according to any one of claims 15 to 17, further comprising a server for data analysis storing software for having the terminal on the data analysis side execute the data analysis and for storing the measured data.

20. A terminal on the side of a pretreatment apparatus for a virtual pretreatment collaboration system, comprising:
a display unit for displaying on a screen pretreatment data of a sample that is to be measured;
a transmission/reception unit for transmitting and receiving data to and from a terminal on the client side through a communication circuit;
a communication unit for communicating with the client side;
an operation unit for controlling indication means on a screen; and
a processing unit for transmitting part or all of said pretreatment data from said transmission/reception unit to said terminal on the client side, and for displaying, on said screen, indication means controlled by a signal from said operation unit and indication means controlled by a signal from said terminal on the client side.

21. A terminal according to claim 20, wherein said display unit simultaneously displays plural pretreatment data.

22. A terminal according to claim 20 or 21, wherein said processing unit displays fees incurred in the pretreatment on said screen together with said pretreatment data.

23. A terminal on the side of an measurement apparatus for a virtual measurement collaboration system, comprising:
a display unit for displaying, on a screen, measured data obtained from the measurement apparatus;
a transmission/reception unit for transmitting and receiving data to and from a terminal on the client side through a communication circuit;
a communication unit for communicating with the client side;
an operation unit for controlling indication means on a screen; and
a processing unit for transmitting part or all of said measured data from said transmission/reception unit to said terminal on the client side, and for displaying, on said screen, indication means controlled by a signal from said operation unit and indication means controlled by a signal from said terminal on the client side.

24. A terminal according to claim 23, wherein said display unit simultaneously displays plural pretreatment data.

25. A terminal according to claim 23 or 24, wherein said processing unit displays fees incurred in the measurement on said screen together with said measured data.

26. A terminal on the person in charge of the analysis side for a virtual analytical collaboration system, comprising:
a display unit for displaying, on a screen, data obtained by analyzing measurement results;
a transmission/reception unit for transmitting and receiving data to and from a terminal on a client side through a communication circuit;
a communication unit for communicating with the client side;
an operation unit for controlling indication means on a screen; and
a processing unit for transmitting part or all of said analytical data from said transmission/reception unit to said terminal on the client side, and for displaying, on said screen, indication means controlled by a signal from said operation unit and indication means controlled by a signal from said terminal on the client side.

27. A terminal according to claim 26, wherein said display unit simultaneously displays plural analytical data.

28. A terminal according to claim 26 or 27, wherein said processing unit displays fees incurred in the data analysis on said screen together with said analytical data.

29. A terminal according to any one of claims 26 to 28, wherein said transmission/reception unit makes an access to at least one of a data analyzing system, an measurement database or an information database.

30. A terminal according to any one of claims 26 to 28, wherein said terminal on the data analysis side makes an access to a server for data analysis, which is storing software for having the data analysis executed and for storing the analytical data.

31. A terminal on the client side comprising:
a transmission/reception unit for transmitting and receiving data to and from a terminal on the side of a pretreatment device, to and from a terminal on the side of an measurement apparatus or to and from a terminal on a data analysis side through a communication circuit;
a display unit for displaying, on a screen, pretreatment data, measured data or analytical data received by the transmission/reception unit;
a communication unit for communicating with the side of the pretreatment apparatus, with the side of the measurement apparatus or with the data analysis side;
an operation unit for controlling indication means on a screen; and
a processing unit for displaying, on the screen of said display unit, indication means controlled by a signal from the operation unit, and indication means controlled by a signal sent from the terminal on the side of the pretreatment apparatus, from the terminal on the side of the measurement apparatus or from the terminal on the data analysis side and received by said transmission/reception unit.

32. A terminal according to claim 31, wherein said display unit simultaneously displays plural pretreatment data, plural measured data or plural analytical data.

33. A terminal according to claim 31 or 32, wherein said processing unit displays the fees incurred in the pretreatment, measurement or data analysis on said screen together with said pretreatment data, said measured data or said analytical data.

34. A virtual pretreatment collaboration method comprising:
a step of displaying pretreatment data on a screen of a display unit on the side of a pretreatment apparatus in pretreating a sample that is to be measured;
a step of displaying part or all of the pretreatment data on a screen of the display unit on a client side which is connected through a communication circuit;
a step of carrying out pretreatment by determining the direction of the pretreatment while communicating between the side of the pretreatment apparatus and the client side by using a communication unit between the side of the pretreatment apparatus and the client side;
a step of displaying indication means on the side of the pretreatment apparatus and indication means on the client side on both the screen of the display unit on the side of the pretreatment apparatus and the screen of the display unit of the client side; and
a step in which the side of the pretreatment apparatus and the client side control their own indication means to indicate a portion to which attention is to be given on the screens.

35. A method according to claim 34, wherein the steps of displaying the pretreatment data display plural pretreatment data simultaneously on the screen of said display unit.

36. A method according to claim 34 or 35, further comprising a step of displaying the fees incurred thus far in the pretreatment on the screen of the display unit on the client side.

37. A virtual measurement collaboration method comprising:
a step of conducting an measurement by using an measurement apparatus and displaying measured data on a screen of a display unit on the side of the measurement apparatus;
a step of displaying part or all of the measured data on a screen of the display unit on a client side which is connected through a communication circuit;
a step of carrying out the measurement by determining the direction of the measurement while communicating between the side of the measurement apparatus and the client side by using a communication unit between the side of the measurement apparatus and the client side;
a step of displaying indication means on the side of the measurement apparatus and indication means on the client side on both the screen of the display unit on the side of the measurement apparatus and the screen of the display unit of the client side; and
a step in which the side of the measurement apparatus and the client side control their own indication means to indicate a portion on which attention is to be given on the screens.

38. A method according to claim 37, wherein the steps of displaying the measured data display plural measured data simultaneously on the screen of said display unit.

39. A method according to claim 37 or 38, further comprising a step of displaying fees incurred thus far in the measurement on the screen of the display unit on the client side.

40. A method according to any one of claims 37 to 39, further comprising a step of transmitting the electronic data obtained by the measurement to the client side through a communication circuit.

41. A virtual analytical collaboration method comprising:
a step of displaying analytical data on a screen of a display unit on a data analysis side in the data analysis of measured results;
a step of displaying part or all of the analytical data on the screen of the display unit of a client side which is connected through a communication circuit;
a step of carrying out the data analysis by determining the direction of the data analysis while communicating between the data analysis side and the client side by using a communication unit between the data analysis side and the client side;
a step of displaying indication means on the data analysis side and indication means on the client side on both the screen of the display unit on the data analysis side and the screen of the display unit of the client side; and
a step in which the data analysis side and the client side control their own indication means to indicate a portion on which attention is to be given on the screens.

42. A method according to claim 41, wherein the steps of displaying the analytical data display plural analytical data simultaneously on the screen of said display unit.

43. A method according to claim 41 or 42, further comprising a step of displaying fees incurred thus far in the data analysis on the screen of the display unit on the client side.

44. A method according to any one of claims 41 to 43, further comprising a step of carrying out the data analysis by using at least one of a data analysis system, a measurement data base or an information database.

45. A method according to any one of claims 41 to 44, further comprising a step of carrying out the data analysis by using at least one of the data analysis system, the measurement database or the information database through a server for data analysis connected through said communication circuit.

46. A program for having a computer execute:
a step of displaying pretreatment data on a screen of a display unit on the side of a pretreatment apparatus in pretreating a sample that is to be measured;
a step of displaying part or all of the pretreatment data on a screen of the display unit of a client side which is connected through a communication circuit;
a step of displaying indication means on the side of the pretreatment apparatus and indication means on the client side on both the screen of the display unit on the side of the pretreatment apparatus and the screen of the display unit of the client side; and
a step in which the side of the pretreatment apparatus and the client side control their own indication means to indicate a portion to which attention is to be given on the screens.

47. A program according to claim 46, wherein the steps of displaying the pretreatment data display plural pretreatment data simultaneously on the screen of said display unit.

48. A program according to claim 46 or 47, further comprising a step of displaying fees incurred thus far in the pretreatment on the screen of the display unit on the client side.

49. A program for having a computer execute:
a step of conducting a measurement by using a measurement apparatus and displaying measured data on a screen of a display unit on the side of the measurement apparatus;
a step of displaying part or all of the measured data on a screen of the display unit on a client side which is connected through a communication circuit;
a step of displaying indication means on the side of the measurement apparatus and indication means on the client side on both the screen of the display unit on the side of the measurement apparatus and the screen of the display unit of the client side; and
a step in which the side of the measurement apparatus and the client side control their own indication means to indicate a portion to which attention is to be given on the screens.

50. A program according to claim 49, wherein the steps of displaying measured data display plural measured data simultaneously on the screen of said display unit.

51. A program according to claim 49 or 50, further comprising a step of displaying fees incurred thus far in the measurement on the screen of the display unit on the client side.

52. A program for having a computer execute:
a step of displaying analytical data on a screen of a display unit on the data analysis side in the data analysis of the measured results;
a step of displaying part or all of the analytical data on the screen of the display unit of a client side which is connected through a communication circuit;
a step of displaying indication means on the data analysis side and indication means on the client side on both the screen of the display unit on the data analysis side and the screen of the display unit of the client side; and
a step in which the data analysis side and the client side control their own indication means to indicate a portion to which attention is to be given on the screens.

53. A program according to claim 52, wherein the steps of displaying the analytical data display plural analytical data simultaneously on the screen of said display unit.

54. A program according to claim 52 or 53, further comprising a step of displaying fees incurred thus far in the data analysis on the screen of the display unit on the client side.

55. A recording medium that can be read by a computer and for storing a program for a computer to execute, said program comprising:
a step of displaying pretreatment data on a screen of a display unit on the side of a pretreatment apparatus in pretreating a sample that is to be measured;
a step of displaying part or all of the pretreatment data on a screen of the display unit of a client side which is connected through a communication circuit;
a step of displaying indication means on the side of the pretreatment apparatus and indication means on the client side on both the screen of the display unit on the side of the pretreatment apparatus and the screen of the display unit of the client side; and
a step in which the side of the pretreatment apparatus and the client side control their own indication means to indicate a portion to which attention is to be given on the screens.

56. A recording medium according to claim 55, wherein the steps of displaying the pretreatment data display plural pretreatment data simultaneously on the screen of said display unit.

57. A recording medium according to claim 55 or 56, further comprising a step of displaying fees incurred thus far in the pretreatment on the screen of the display unit on the client side.

58. A recording medium that can be read by a computer and for storing a program for a computer to execute, said program comprising:
a step of conducting a measurement by using an measurement apparatus and displaying measured data on a screen of a display unit on the side of the measurement apparatus;
a step of displaying part or all of the measured data on the screen of the display unit of a client side which is connected through a communication circuit;
a step of displaying indication means on the side of the measurement apparatus and indication means on the client side on both the screen of the display unit on the side of the measurement apparatus and the screen of the display unit of the client side; and
a step in which the side of the measurement apparatus and the client side control their own indication means to indicate a portion to which attention is to be given on the screens.

59. A recording medium according to claim 58, wherein the steps of displaying the measured data display plural measured data simultaneously on the screen of said display unit.

60. A recording medium according to claim 58 or 59, further comprising a step of displaying fees incurred thus far in the measurement on the screen of the display unit on the client side.

61. A recording medium that can be read by a computer and for storing a program for a computer to execute, said program having:
a step of displaying analytical data on a screen of a display unit on the data analysis side in the data analysis of the measured results;
a step of displaying part or all of the analytical data on the screen of the display unit of a client side which is connected through a communication circuit;
a step of displaying indication means on the data analysis side and indication means on the client side on both the screen of the display unit on the data analysis side and the screen of the display unit of the client side; and
a step in which the data analysis side and the client side control their own indication means to indicate a portion to which attention is to be given on the screens.

62. A recording medium according to claim 61, wherein the steps of displaying the analytical data display plural analytical data simultaneously on the screen of said display unit.

63. A recording medium according to claim 61 or 62, further comprising a step of displaying fees incurred thus far in the data analysis on the screen of the display unit on the client side.
